(19) United States
(12) Patent Application Publication
(10) Pub. No.: US 2020/0319511 A1
(43) Pub. Date: Oct. 8, 2020

(54) AREA LIGHT SOURCE DEVICE AND DISPLAY DEVICE

(71) Applicant: Enplas Corporation, Saitama (JP)

(72) Inventors: Takahiro IZAWA, Saitama (JP); Kyouhei YAMADA, Saitama (JP)

(73) Assignee: Enplas Corporation, Saitama (JP)

(21) Appl. No.: 16/765,489

(22) PCT Filed: Oct. 26, 2018
(86) PCT No.: PCT/JP2018/039852

§ 371 Date: May 20, 2020

(30) Foreign Application Priority Data
Nov. 20, 2017 (JP) 2017-222891

(51) Int. Cl. G02F 1/13357

(52) U.S. Cl. CPC G02F 1/133606; G02F 2001/133607; G02F 1/133603; G02F 1/133611

(57) ABSTRACT

The luminous intensity of light which is emitted from the light-emitting device and of which the angle with respect to the optical axis has the absolute value of from 0 to 60° is not more than 1.5% with respect to the maximum luminous intensity of light emitted from the light-emitting device. An angular range in which light of a luminous intensity of not less than 70% of the maximum luminous intensity is emitted, the absolute value of the maximum angle with respect to the optical axis is θ, an output surface is disposed so as to intersect a straight line of which the major angle, among the angles formed by the optical axis and a straight line passing a bottom surface-side end portion of the inclined surface and intersecting the optical axis, is not less than θ.

### TECHNICAL FIELD

The present invention relates to a surface light source device and a display device.

### BACKGROUND ART

Some transmission type image display devices such as liquid crystal display devices use a direct surface light source device. In recent years, direct surface light source devices including a plurality of light emitting elements as the light sources are used (see, for example, PTL 1).

A planar light emitting device (surface light source device) disclosed in Patent Literature (hereinafter also referred to as “PTL”) 1 includes a casing, a support plate disposed in the casing, a mounting substrate disposed on the support plate, and a plurality of light source units for light radiation (light emitting devices) disposed on the mounting substrate, and a diffusion and transmission part disposed to cover the opening of the casing. The light source unit for light radiation includes a spacer, an LED disposed on the spacer, and an optical element for light direction change disposed on the LED.

The planar light emitting device of PTL 1 controls light emitted from the LED by the optical element for light direction change in such a manner that the light travels in the direction along the optical axis of the LED, the direction orthogonal to the optical axis, and the direction toward the mounting substrate rather than the optical element for light direction change. The light travelling in the direction toward the mounting substrate rather than the optical element for light direction change is reflected by the mounting substrate or the support plate toward the diffusion and transmission part. The planar light emitting device of PTL 1 thus uniformly illuminate the diffusion and transmission part.

### CITATION LIST

### Patent Literature

PTL 1 Japanese Patent Application Laid-Open No. 2007-048883

### SUMMARY OF INVENTION

### Technical Problem

In the planar light emitting device of PTL 1, the quality of the diffusion and transmission part may decrease depending on the relationship between the disposition of the light source unit for light radiation and the light distribution characteristics of the light source unit for light radiation. For example, when the light source unit for light radiation is disposed close to the diffusion and transmission part, the distance from the light source unit for light radiation to the diffusion and transmission part becomes short, thereby possibly forming a bright part at a part immediately above the light source unit for light radiation. In the conventional surface light source device, the uniformity on the diffusion and transmission part may thus decrease depending on the position of the light emitting device.

An object of the present invention is to provide a surface light source device and a display device both having high uniformity.

### Solution to Problem

The surface light source device of the present invention includes: a casing with an opening, the casing having a shape of a box; a substrate disposed in the casing; a light emitting device disposed on the substrate; and a light diffusion plate disposed so as to cover the opening. The light emitting device includes a light emitting element, and a light flux controlling member configured to control light distribution of light emitted from the light emitting element. The casing includes a bottom surface on which the substrate is disposed, and an inclined surface disposed at a position further than the bottom surface from an optical axis of the light emitting element in a cross section including the optical axis. In the cross section including the optical axis, the inclined surface is tilted so as to approach the light diffusion plate as a distance of the inclined surface from the optical axis increases. The light flux controlling member includes an incidence surface disposed on a rear side so as to intersect with the optical axis, and the incidence surface being configured to allow incidence of the light emitted from the light emitting element, a rear surface disposed so as to surround the incidence surface, the rear surface extending away from the optical axis, a reflection surface disposed on a front side and configured to reflect part of the light incident on the incidence surface into a direction substantially perpendicular to the optical axis, and an emission surface disposed so as to connect between the reflection surface and the rear surface, the emission surface being configured to emit the light reflected by the reflection surface and the light incident on the incidence surface to an outside. In the cross section including the optical axis, a luminous intensity of first light is 1.5% or less relative to a maximum luminous intensity of light emitted from the light emitting device, the first light being emitted from the light emitting device and having an angle with an absolute value of 0 to 60° relative to the optical axis, and the emission surface is disposed so that, in the cross section including the optical axis, when an absolute value of an maximum angle relative to the optical axis is set as θ, the emission surface intersects with a straight line having an angle equals to or more than θ, wherein the angle is larger one of angles between the optical axis and the straight line that passes an end of the inclined surface on a bottom surface side and intersects with the optical axis, the maximum angle being in an angle range in which light having a luminous intensity of 70% or more of the maximum luminous intensity is emitted.

A display device of the present invention includes the surface light source device according to present invention and a display member disposed on the light diffusion plate.

### Advantageous Effects of Invention

The surface light source device and display device according to the present invention are capable of exhibiting high uniformity.

### BRIEF DESCRIPTION OF DRAWINGS

FIGS. 1A to 1C illustrate a configuration of a surface light source device according to the present embodiment 1;

FIGS. 2A to 2C illustrate the configuration of the surface light source device according to the present embodiment 1;

FIG. 3 is a cross-sectional view of a light flux controlling member;

FIG. 4 is a graph showing a relationship between angles of light beams emitted from a light emitting device and relative luminous intensities of the light beams;

FIG. 5 is a schematic view for explaining the disposition of an emission surface in the light emitting device;

FIGS. 6A and 6B illustrate optical paths of a part of light beams in the surface light source device;

FIG. 7 is a graph showing the light distribution characteristics of light emitted from the light emitting device;

FIGS. 8A and 8B are cross-sectional views illustrating a configuration of a surface light source device according to a modification; and

FIGS. 9A to 9C illustrate a configuration of a surface light source device according to embodiment 2.

### DESCRIPTION OF EMBODIMENT

An embodiment of the present invention will be described in detail below with reference to the accompanying drawings.

### Embodiment 1

(Configuration of Surface Light Source Device)

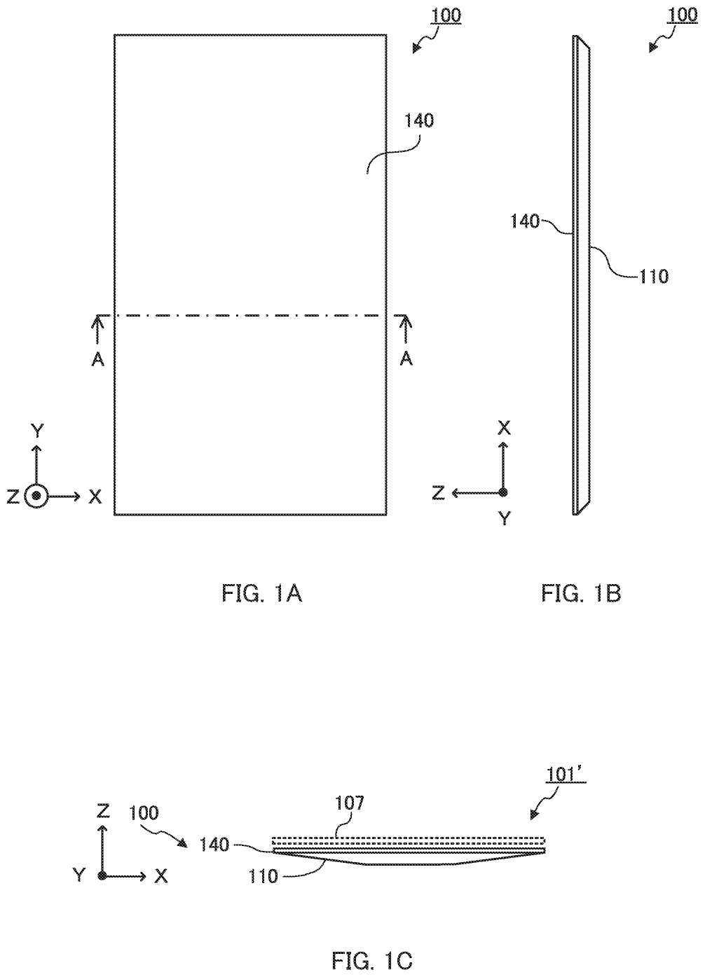

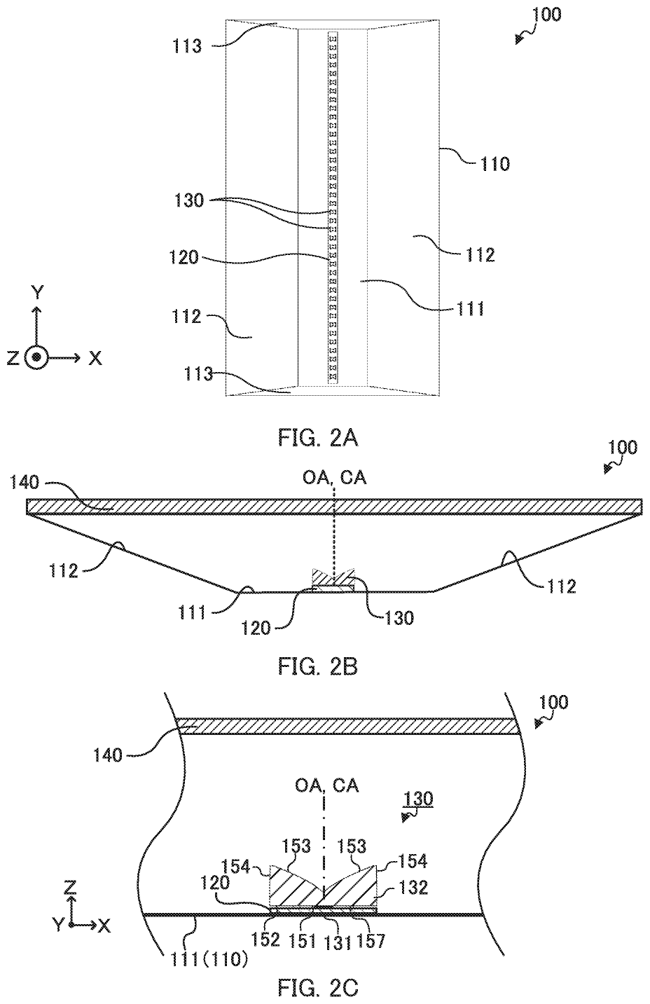

FIGS. 1A to 1C and 2A to 2C illustrate a configuration of surface light source device 100 according to embodiment 1. FIG. 1A is a plan view of surface light source device 100, and FIG. 1B is a side view and FIG. 1C is a front view thereof. FIG. 2A is a plan view of surface light source device 100 of FIG. 1A with light diffusion plate 140 removed, FIG. 2B is a schematic cross-sectional view of surface light source device 100, FIG. 2C is a partially enlarged cross-sectional view taken along line A-A of FIG. 1A. In the following, the description is made with the direction parallel to optical axis OA of light emitting element 131 as Z direction, the array direction of light emitting devices 130 which is orthogonal to Z direction as Y direction, and the direction perpendicular to Z direction and Y direction as X direction. For a single light emitting device 130, the description is made with the axes, from the original that is the light emission center of light emitting element 131, in X direction, Y direction and Z direction as X axis, Y axis and Z axis, respectively.

As illustrated in FIGS. 1A to 1C and 2A to 2C, surface light source device 100 includes casing 110, substrate 120, a plurality of light emitting devices 130 and light diffusion plate 140. In addition, as illustrated in FIG. 1C, surface light source device 100 may be used as display device 101′ in combination with a display member (member to be irradiated) 107 such as a liquid crystal panel (shown by dotted line in FIG. 1C).

Casing 110 is formed in a shape of a box with at least a part thereof is open and is used for housing substrate 120 and the plurality of light emitting devices 130 inside. In the present embodiment, casing 110 includes bottom surface 111, two first inclined surfaces (tilted surfaces) 112 and two second inclined surfaces 113.

Bottom surface 111 is a rectangular surface in plan view. Substrate 120 is disposed on bottom surface 111. Two first inclined surfaces 112 are respectively connected to two sides of bottom surface 111 in the transverse direction. Two second inclined surfaces 113 are respectively connected to two sides of bottom surface 111 in the longitudinal direction. In bottom surface 111, as long as a region with substrate 120 disposed thereon is flat, a region with no substrate 120 disposed thereon is not necessarily be disposed on the same plane as the region with substrate 120 disposed thereon.

Two first inclined surfaces 112 are disposed parallel to the array direction of the plurality of light emitting devices 130 and disposed on both sides of bottom surface 111 respectively with bottom surface 111 between two first inclined surfaces 112. In a virtual cross section perpendicular to the array direction of the plurality of light emitting devices 130 (cross section including optical axis OA), first inclined surface 112 is tilted so as to approach light diffusion plate 140 as the distance of first inclined surface 112 from optical axis OA increases. First inclined surface 112 may be a flat surface, a curved surface protruding toward light diffusion plate 140 side or a curved surface concave relative to light diffusion plate 140. The inclination angle of first inclined surface 112 relative to bottom surface 111 is preferably more than 6° and less than 9°, and more preferably 7° or more and less than 9°. When first inclined surface 112 is a curved surface, the “inclination angle of first inclined surface 112 relative to bottom surface 111” refers to an “inclination angle of the tangent on first inclined surface 112 relative to bottom surface 111.” When the inclination angle of first inclined surface 112 relative to bottom surface 111 is more than 6° and less than 9°, light emitted from light emitting device 130 and reflected by first inclined surface 112 widely reaches the external edge of light diffusion plate 140.

In the present embodiment, the inclination angle of first inclined surface 112 relative to bottom surface 111 is set based on the opening edge of casing 110. That is, casing 110 does not include a side surface perpendicular to bottom surface 111 in the present embodiment. When the inclination angle of first inclined surface 112 relative to bottom surface 111 is large, the size of first inclined surface 112 becomes small. On the other hand, when the inclination angle of first inclined surface 112 relative to bottom surface 111 is small, the size of first inclined surface 112 becomes large.

In the array direction (Y direction) of the plurality of light emitting devices 130, second inclined surfaces 113 are disposed on both sides of bottom surface 111 respectively. Second inclined surface 113 is formed so as to approach light diffusion plate 140 as the distance of second inclined surface 113 from optical axis OA increases. The inclination angle of second inclined surface 113 relative to bottom surface 111 is approximately 40° to 50°. Two second inclined surfaces 113 may be a flat surface, a curved surface protruding toward light diffusion plate 140 side or a curved surface concave relative to light diffusion plate 140.

With casing 110 in such a shape, the thickness of the surface light source device 100 seen from the outside can be reduced. The size of the opening of casing 110 corresponds to the size of the light emitting region formed on light diffusion plate 140, and is, for example, 400 mm×700 mm. Light diffusion plate 140 covers the opening. The height from the surface of bottom surface 111 to light diffusion plate 140 (i.e. thickness of the space) may be any value, and is approximately 10 to 40 mm. Casing 110 is formed of a material of, for example, a light-transmissive resin such as polymethylmethacrylate (PMMA) or polycarbonate (PC), or a metal such as stainless steel or aluminum.

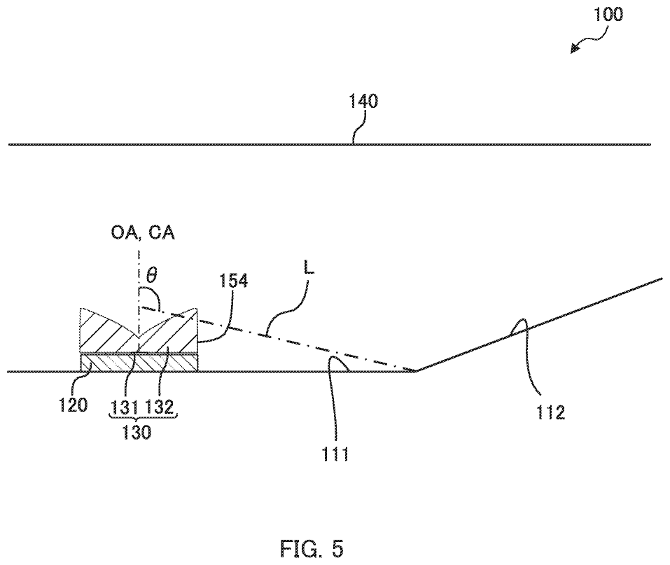

Substrate 120 is disposed on bottom surface 111 of casing 110. Substrate 120 is a flat plate for the plurality of light emitting devices 130 to be disposed thereon at predetermined intervals in casing 110. The size of substrate 120 is appropriately set as long as light emitting device 130 can be disposed thereon and a light beam emitted from emission surface 154 does not reach substrate 120. In the present embodiment, the length of substrate 120 in the X axis direction is the same as the length of light flux controlling member 132 in the X axis direction. In the present embodiment, substrate 120 has a predetermined thickness. The thickness of substrate 120 is set as follows: in the virtual cross section, when set as θ is the absolute value of the maximum angle, in an angle range in which light having a luminous intensity of 70% or more of the maximum luminous intensity is emitted, relative to optical axis OA (hereinafter, also referred to as “the absolute value θ of the maximum angle”), emission surface 154 intersects with straight line L (see FIG. 5) having an angle equals to or more than θ, where the angle is larger one of the angles between optical axis OA and the straight line that passes the end of first inclined surface 112 on bottom surface 111 side and intersects with optical axis OA. The upper limit of “θ” is 180°, which means the angle at which the luminous intensity can be detected.

The plurality of light emitting devices 130 are arranged in one direction (Y direction) on substrate 120. The plurality of light emitting devices 130 may be arranged in one row, or in more than one row. In both cases, each row is along Y direction. The distances between adjacent light emitting devices 130 in the array direction (Y direction) of the plurality of light emitting devices 130 may be the same or different. In the present embodiment, light emitting devices 130 are arranged on substrate 120 in one row along Y direction. In addition, the plurality of light emitting devices 130 are disposed at regular intervals in Y direction. The number of light emitting devices 130 disposed on substrate 120 is not limited. The number of light emitting devices 130 disposed on substrate 120 is appropriately set on the basis of the size of the light emitting region (light emitting surface) defined by the opening of casing 110.

Each of light emitting devices 130 includes light emitting element 131 and light flux controlling member 132. Each of light emitting devices 130 is disposed such that the optical axis (optical axis OA of light emitting element 131 described below) of light emitted from light emitting element 131 is set along the normal to the surface of substrate 120.

In a virtual cross section perpendicular to the array direction of the plurality of light emitting devices 130 (cross section including optical axis OA and X axis), the luminous intensity of light, which is emitted from light emitting device 130 and has an angle with an absolute value of 0 to 60° relative to optical axis OA, is 1.5% or less relative to the maximum luminous intensity of light emitted from light emitting device 130 (hereinafter, also referred to as “maximum luminous intensity”). The luminous intensity of light, which is emitted from light emitting device 130 and has an angle with an absolute value of 0 to 60° relative to optical axis OA, is preferably 1.0% or less and more preferably 0.5% or less relative to the maximum luminous intensity. When the luminous intensity of light, which is emitted from light emitting device 130 and has an angle with an absolute value of 0 to 60° relative to optical axis OA, is 1.5% or less relative to the maximum luminous intensity, a bright part at a part immediately above light emitting device 130 is not formed even when the distance between light emitting device 130 and light diffusion plate 140 becomes short.

Relative to the maximum luminous intensity, the luminous intensity of the light having an angle with an absolute value of 0 to 60° relative to optical axis OA can be confirmed as follows. Firstly, the light distribution characteristics of light emitting device 130 with the direction along optical axis OA set as 0° are analyzed. Secondly, the maximum luminous intensity is compared with the luminous intensity of the light having an angle with an absolute value of 0 to 60° relative to optical axis OA.

Light emitting element 131 is a light source of surface light source device 100 (and light emitting device 130). Light emitting element 131 is disposed on substrate 120. Light emitting element 131 is, for example, a light emitting diode (LED). The color of light emitted from light emitting element 131 can be appropriately set. The color of light emitted from light emitting element 131 may be white or blue. In the present embodiment, the color of light emitted from light emitting element 131 is white. The normal to the surface of substrate 120 is parallel to optical axis OA of light emitting element 131.

Light flux controlling member 132 is configured to control the light distribution of light emitted from light emitting element 131. Light flux controlling member 132 is disposed above light emitting element 131 in such a manner that central axis CA of light flux controlling member 132 coincides with optical axis OA of light emitting element 131 (see FIGS. 2B and 2C). “Optical axis OA of light emitting element 131” refers to a central light beam of a stereoscopic light flux emitted from light emitting element 131. In the present embodiment, “central axis CA of light flux controlling member 132” refers to, for example, a symmetric axis of 2-fold rotational symmetry.

The material of light flux controlling member 132 is not limited as long as light having a desired wavelength can pass therethrough. The material of light flux controlling member 132 is, for example, a light-transmissive resin such as polymethylmethacrylate (PMMA), polycarbonate (PC) or epoxy resin (EP), or glass.

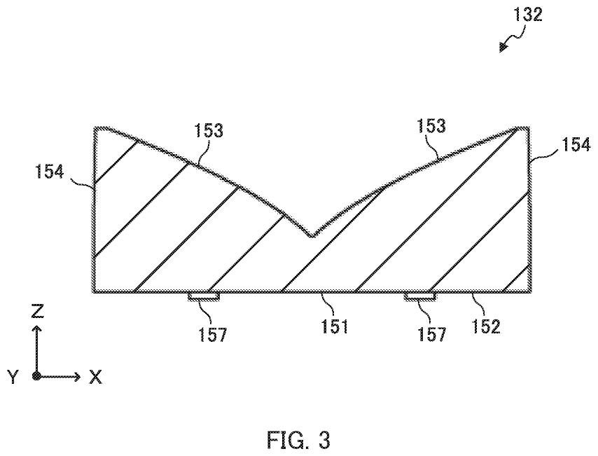

FIG. 3 is a cross-sectional view of light flux controlling member 132. As illustrated in FIG. 3, light flux controlling member 132 includes incidence surface 151, rear surface 152, two reflection surfaces 153 and two emission surfaces 154. In the present embodiment, light flux controlling member 132 further includes four legs 157.

Incidence surface 151 is configured to allow light emitted from light emitting element 131 to enter the inside of light flux controlling member 132. Incidence surface 151 is disposed on the rear side of light flux controlling member 132 (substrate 120 and light emitting element 131 side) so as to intersect with optical axis OA. The shape of incidence surface 151 can be appropriately set as long as the above function can be obtained. The shape of incidence surface 151 may be that of a flat surface, or an inner surface of a recess opened on rear surface 152. In the present embodiment, the shape of incidence surface 151 is that of a flat surface. Rear surface 152, having legs 157 disposed thereon, is formed outside incidence surface 151 relative to optical axis OA so as to surround incidence surface 151.

Two reflection surfaces 153 are disposed on the front side of light flux controlling member 132 (light diffusion plate 140 side) opposite to light emitting element 131 with incidence surface 151 therebetween. Two reflection surfaces 153 are configured to reflect at least part of light incident on incidence surface 151 into the directions substantially perpendicular to optical axis OA of light emitting element 131, and substantially opposite to each other (both along X axis). Each of two reflection surfaces 153 is formed so as to approach light diffusion plate 140 as the distance of reflection surface 153 from optical axis OA increases. Specifically, each of two reflection surfaces 153 is formed so that the inclination of the tangent of the reflection surface gradually decreases (so that the reflection surface is set along X axis) from optical axis OA of light emitting element 131 toward the end of the reflection surface (emission surface 154). Part of light that is emitted from light emitting element 131 and incident on incidence surface 151 is reflected by reflection surface 153 and travels toward emission surface 154. In addition, another part of the light that is emitted from light emitting element 131 and incident on incidence surface 151 (specifically light emitted from the external edge of the light emitting surface of light emitting element 131) includes a light component emitted from emission surface 154 toward the outside of light flux controlling member 132 without being reflected by reflection surface 153.

Each of two emission surfaces 154 is disposed so as to connect rear surface 152 and reflection surface 153. Emission surface 154 is configured to emit light incident on incidence surface 151 to the outside. Emission surface 154 is substantially parallel to optical axis OA. Emission surface 154 may be a flat surface or a curved surface. The phrase “substantially parallel to optical axis OA” means that, in the virtual cross section, a smaller one of the angles between a straight line parallel to optical axis OA and emission surface 154 is 0° to 3° or less. When emission surface 154 is a curved surface, the angle is referred to a smaller one of the angles between optical axis OA and the tangent of a curved line in the cross section including optical axis OA of emission surface 154 and X axis. In the present embodiment, emission surface 154 is a flat surface formed so as to be directed toward the rear side as the distance of emission surface 154 from optical axis OA increases in the virtual cross section perpendicular to the array direction of the plurality of light emitting devices 130 (cross section including optical axis OA and X axis).

Emission surface 154 is disposed so that, in the virtual cross section, when the absolute value of the maximum angle, in an angle range in which light having a luminous intensity of 70% or more of the maximum luminous intensity is emitted, relative to optical axis OA is set as θ, emission surface 154 intersects with straight line L having an angle equals to or more than θ, where the angle is larger one of the angles between optical axis OA and the straight line that passes the end of first inclined surface 112 on bottom surface 111 side and intersects with optical axis OA.

Four legs 157 are substantially columnar members protruding from rear surface 152 toward the rear side. Legs 157 support light flux controlling member 132 at an appropriate position relative to light emitting element 131 (see FIG. 3). Leg 157 may be used for positioning by fitting the leg into a hole formed in substrate 120. The positions, shapes and number of legs 157 are appropriately set so that legs 157 do not cause optically adverse effects as long as light flux controlling member 132 can be stably fixed on substrate 120. In the present embodiment, two legs 157 between incidence surface 151 and emission surface 154, four legs in total, are disposed in X-direction.

Light diffusion plate 140 is disposed so as to cover the opening of casing 110. Light diffusion plate 140 is a plate-shaped member having a light transmitting property and a light diffusing property, and allows light emitted from light emitting device 130 to pass therethrough while diffusing the light. Light diffusion plate 140 may serve as the light emitting surface of surface light source device 100. Light diffusion plate 140 includes, for example, a light diffusion plate or an optical sheet.

The material of light diffusion plate 140 can be appropriately selected from materials that allow light emitted from light emitting device 130 to pass therethrough while diffusing the light. Examples of the materials of light diffusion plate 140 include light-transmissive resins such as polymethylmethacrylate (PMMA), polycarbonate (PC), polystyrene (PS) and styrene-methylmethacrylate copolymer resin (MS). For providing a light diffusing property to light diffusion plate 140, fine irregularities are formed on the surface of light diffusion plate 140, or light diffusion elements such as beads are dispersed in light diffusion plate 140.

In surface light source device 100 according to the present embodiment, light emitted from each light emitting element 131 is converted by and emitted from light flux controlling member 132 as light traveling, in particular, in two directions that are substantially perpendicular to optical axis OA of light emitting element 131 and are substantially opposite to each other (two directions along X axis in FIG. 3) so as to illuminate a wide range of light diffusion plate 140. Among light beams emitted from each light flux controlling member 132, most of the light beams are reflected by first inclined surface 112, further diffused by light diffusion plate 140, and emitted outside. The uniformity of surface light source device 100 thus can be increased.

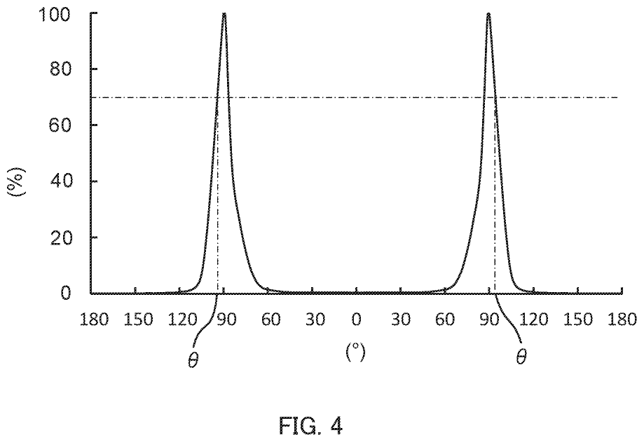

In the following, light distribution characteristics of light emitting device 130 in surface light source device 100 of the present embodiment is analyzed. FIG. 4 is a graph showing a relationship between angles of light beams emitted from light emitting device 130 and relative luminous intensities of the light in the virtual cross section. The abscissa of FIG. 4 indicates absolute values of the angles)(° with the direction along optical axis OA set as 0°. The ordinate of FIG. 4 indicates the relative luminous intensities (%) with the maximum luminous intensity set as 100%.

As shown in FIG. 4, in light emitting device 130 of surface light source device 100 of the present embodiment, the luminous intensity of a light beam traveling in the direction of approximately 90° is the highest with the direction along optical axis OA set as 0° in the virtual cross section. In addition, in the cross section including optical axis OA and X axis, the luminous intensity of a light beam whose angle relative to optical axis OA has an absolute value in a range of 0° to 60° is 1.5% or less relative to the maximum luminous intensity, and the luminous intensity observed in a range of 0° to 50° is less than 1.0%. The absolute value of an angle at which the luminous intensity can be detected is 120° relative to optical axis OA.

In the following, the disposition of light emitting device 130 is analyzed. FIG. 5 is a schematic view for explaining the disposition of emission surface 154 in light emitting device 130. As illustrated in FIG. 5, emission surface 154 of light emitting device 130 (light flux controlling member 132) is disposed so as to intersect with straight line L whose larger one of the angles between optical axis OA and the straight line passing the end of first inclined surface 112 on bottom surface 111 side and intersecting with optical axis OA equals to or more than absolute value θ of the maximum angle. In the present embodiment, the height of emission surface 154 (light emitting device 130) is adjusted by substrate 120 in order to dispose emission surface 154 so that the above condition is satisfied. By disposing light emitting device 130 so that the above condition is satisfied, in the virtual cross section, light emitted at an angle equals to or more than θ among light emitted from emission surface 154 reaches ⅔ of a region from first inclined surface 112 side, where the region is between optical axis OA and the end of bottom surface 111 on first inclined surface 112 side and is divided into three equal parts. The light emitted from emission surface 154 and reaching bottom surface 111 is reflected toward light diffusion plate 140.

In the following, analyzed is an optical path of a light beam emitted from emission surface 154 when substrate 120 is thickened as in surface light source device 100 according to the present embodiment. As the comparison, surface light source device 100′ of comparative example in which substrate 120 is not thickened is also analyzed.

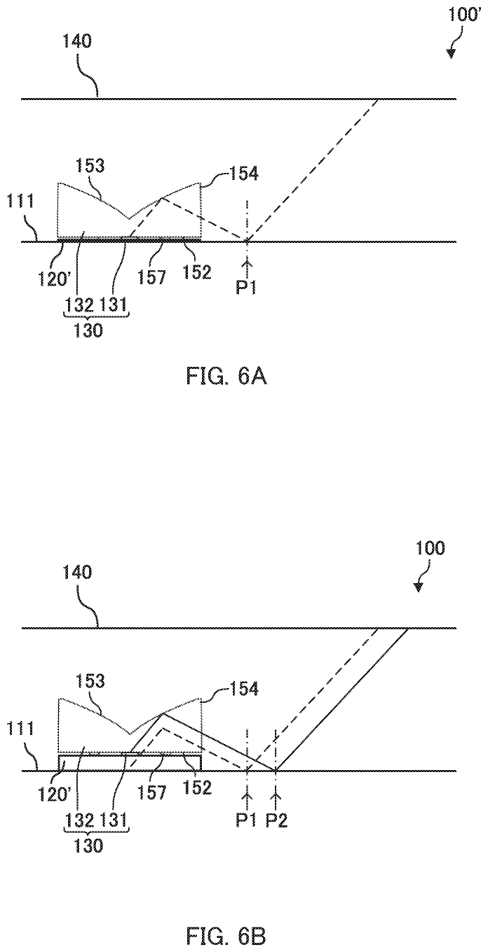

FIG. 6A illustrates an optical path of a part of light beams in surface light source device 100′ of comparative example, and FIG. 6B illustrates an optical path of a part of light beams in surface light source device 100 according to the present embodiment. The light emission angles of the light beams illustrated in FIGS. 6A and 6B are the same. The distance from the surface of substrate 120 to the rear surface of light diffusion plate 140 is 28 mm in surface light source device 100, and 30 mm in surface light source device 100′.

As illustrated in FIGS. 6A and 6B, the reaching position (P2) of a light beam on bottom surface 111 in surface light source device 100 with thick substrate 120 of the present embodiment is further from optical axis OA than the reaching position (P1) in surface light source device 100′ of comparative example with thin substrate 120. In addition, the reaching position of the light, reflected by bottom surface 111 (at P2), on light diffusion plate 140 in surface light source device 100 with thick substrate 120 of the present embodiment is further from optical axis OA than the reaching position of the light (reflected at P1) in surface light source device 100′ of comparative example with thin substrate 120′. This can be considered because, in surface light source device 100 according to the present embodiment, substrate 120 is thicker than substrate 120′ of the comparative example and the position where light is emitted from emission surface 154 is higher (located on light diffusion plate 140 side) than in surface light source device 100′ of the comparative example.

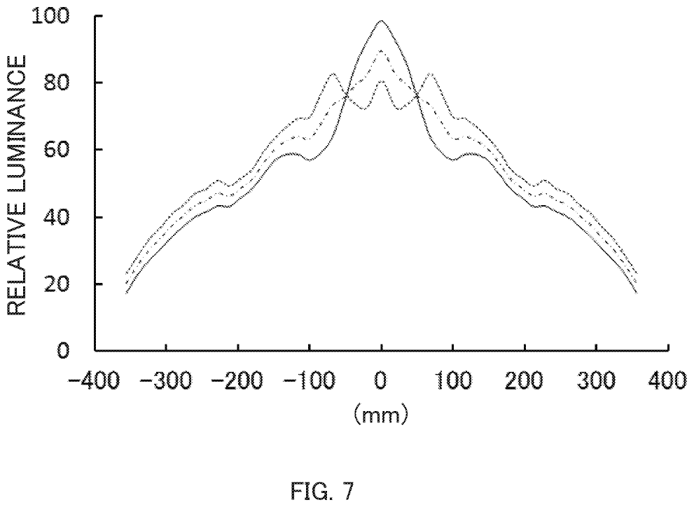

The luminance distribution on light diffusion plate 140 in surface light source device 100 is then analyzed. FIG. 7 shows the relationship between the distance (mm) from optical axis OA on light diffusion plate 140 and relative luminance (%) on light diffusion plate 140, in the cross section including optical axis OA and X axis (virtual cross section). The abscissa of FIG. 7 is the distance (mm) from optical axis OA on light diffusion plate 140. The ordinate of FIG. 7 is relative luminance (%) on light diffusion plate 140. In FIG. 7, the solid line shows the result when the distance is 30 mm between the surface of substrate 120 and light diffusion plate 140 in surface light source device 100′ of the comparative example, and the chain line and the dotted line respectively show the results when the distances are 28 mm and 27 mm between the surface of substrate 120 and light diffusion plate 140 in surface light source device 100 of the present embodiment.

It can be seen from FIG. 7 that the shorter the distance between the surface of substrate 120 and light diffusion plate 140 becomes, the lower the relative luminance immediately above light emitting device 130 becomes. In the central part of light diffusion plate 140 immediately above light emitting device 130, it is considered that as the distance between the surface of substrate 120 and light diffusion plate 140 is reduced, light emitting device 130 approaches light diffusion plate 140, thereby increasing the luminance. In the outer peripheral part of light diffusion plate 140 that is not immediately above light emitting device 130, it is considered that as an emitting position at emission surface 154 approaches light diffusion plate 140 side, the reaching position on light diffusion plate 140 becomes further from optical axis OA. The luminous intensity of light emitted from light emitting device 130 and having a small angle relative to optical axis OA is extremely low compared to the maximum luminous intensity (see FIG. 4). Therefore, even if the distance between light emitting device 130 and light diffusion plate 140 is shortened, the luminance does not increase significantly. On the other hand, the luminous intensity of light emitted from light emitting device 130 and having a large angle relative to optical axis OA is extremely high (see FIG. 4). Therefore, when the distance between light emitting device 130 and light diffusion plate 140 is shortened, the reaching positions of many light beams on light diffusion plate 140 change. Since the amount of increase in luminance at the outer peripheral part away from light emitting device 130 is larger than at the part immediately above light emitting device 130, it is considered that the luminance of the central part of light diffusion plate 140 becomes relatively low, and the luminance of the outer peripheral part of light diffusion plate 140 becomes relatively high.

[Modification]

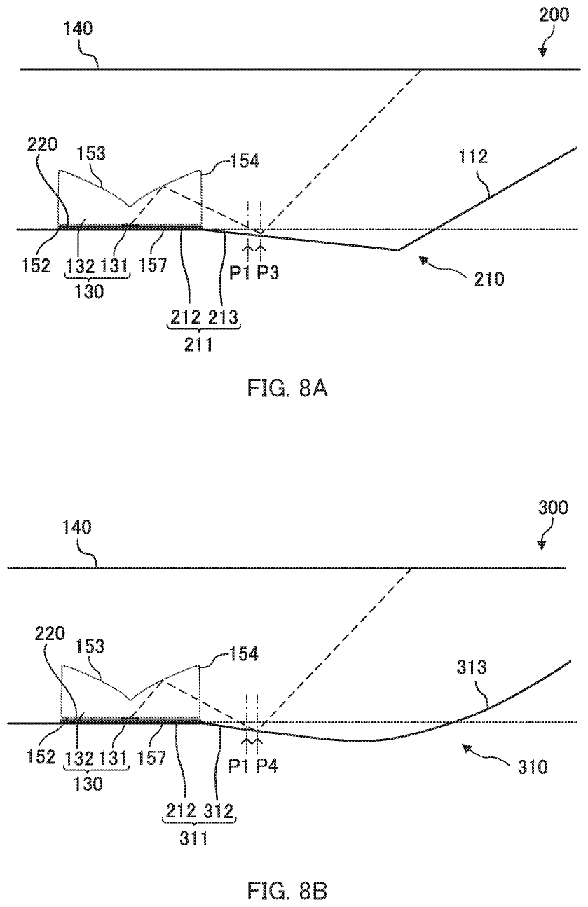

In the following, surface light source devices 200 and 300 of modifications of the present embodiment 1 are described. FIG. 8A is a schematic cross-sectional view of surface light source device 200 of modification 1, and FIG. 8B is a schematic cross-sectional view of surface light source device 200 of modification 2. Points P1 in FIGS. 8A and 8B show a reaching position of a light beam having the same light emission angle as that in FIGS. 8A and 8B on bottom surface 211 in surface light source device 100′ of the comparative example.

[Modification 1]

Surface light source device 200 according to modification 1 of embodiment 1 has a configuration of casing 210 and substrate 220 different from that of surface light source device 100 according to embodiment 1. Therefore, the configuration different from that of surface light source device 100 is mainly described in the modification.

As illustrated in FIG. 8A, surface light source device 200 according to the present modification includes casing 210, substrate 220, light emitting device 130 and light diffusion plate 140. Casing 210 includes bottom surface 211, two first inclined surfaces 112 and two second inclined surfaces 113.

Bottom surface 211 includes first bottom surface 212 and two second bottom surfaces 213. First bottom surface 212 is a flat plate on which substrate 120 is disposed. First bottom surface 212 may have any size as long as the size is larger than that of substrate 120. Two second bottom surfaces 213 are disposed parallel to the array direction of the plurality of light emitting devices 130 and disposed on both sides of first bottom surface 212 respectively with first bottom surface 212 between two second bottom surfaces 213. In the virtual cross section perpendicular to the array direction of the plurality of light emitting devices 130, first bottom surface 212 is tilted away from light diffusion plate 140 as the distance of first bottom surface 212 from optical axis OA increases. The inclination angle of second bottom surface 213 relative to first bottom surface 211 is preferably more than 6° and less than 9°, and more preferably 7° or more and less than 9°.

Also in the present modification, in the cross section, the luminous intensity of light emitted from light emitting device 130 and having an angle relative to optical axis OA with an absolute value in a range of 0° to 60° is 1.5% or less relative to the maximum luminous intensity of light emitted from light emitting device 130. In addition, emission surface 154 is disposed so that, in the virtual cross section, when the absolute value of the maximum angle, in an angle range in which light having a luminous intensity of 70% or more of the maximum luminous intensity is emitted, relative to optical axis OA is set as θ, emission surface 154 intersects with straight line L having an angle equals to or more than θ, where the angle is larger one of the angles between optical axis OA and the straight line that passes the end of first inclined surface 112 on bottom surface 211 side and intersects with optical axis OA.

The inclination angle of second bottom surface 213 relative to first bottom surface 212 and the thickness of substrate 220 are appropriately set as long as emission surface 154 is disposed so as to intersect with above-described straight line L. The inclination angle of second bottom surface 213 relative to first bottom surface 212 may be, for example, increased to reduce the thickness of substrate 220. Alternatively, the inclination angle of second bottom surface 213 relative to first bottom surface 212 may be reduced to increase the thickness of substrate 220.

In surface light source device 200 of the present embodiment with second bottom surface 213 being an inclined surface, the reaching position (P3) of a light beam on bottom surface 211 is further from optical axis OA than the reaching position (P1) in surface light source device 100′ of the comparative example with bottom surface 111 being a flat surface.

Therefore, in the virtual cross section, a light beam emitted from light emitting device 130 at an angle equals to or more than θ reaches ⅔ of a region from first inclined surface 112 side where the region is between optical axis OA and the end of bottom surface 211 on first inclined surface 112 side, and is divided into three equal parts. With this disposition, a light beam emitted from light emitting device 130 can reach a position further from optical axis OA on bottom surface 211. Therefore, luminance on light diffusion plate 140 can be made uniform compared to conventional surface light source device 100′ by allowing light reflected by bottom surface 211 to reach a position further from optical axis OA on light diffusion plate 140 than in surface light source device 100′ of the comparative example according to the inclination direction and reflection characteristics of bottom surface 211.

[Modification 2]

Surface light source device 300 according to modification 2 of embodiment 1 has a configuration of casing 310 different from that of surface light source device 200 according to modification 1 of embodiment 1. Therefore, the configuration different from that of surface light source device 200 is mainly described in the modification.

As illustrated in FIG. 8B, surface light source device 300 according to the present modification includes casing 310, substrate 220, light emitting device 130 and light diffusion plate 140. Casing 310 includes bottom surface 311, two first inclined surfaces 313 and two second inclined surfaces 113.

Bottom surface 311 includes first bottom surface 212 and two second bottom surfaces 312. First bottom surface 212 is a flat plate on which substrate 120 is disposed. Two second bottom surfaces 312 are disposed parallel to the array direction of the plurality of light emitting devices 130 and disposed on both sides of first bottom surface 212 respectively with first bottom surface 212 between two second bottom surfaces 312. In the virtual cross section perpendicular to the array direction of the plurality of light emitting devices 130, second bottom surface 312 is tilted away from light diffusion plate 140 as the distance of second bottom surface 312 from optical axis OA increases. In the present embodiment, second bottom surface 312 is a curved surface concave relative to light diffusion plate 140 side in the virtual cross section.

Two first inclined surfaces 313 are disposed parallel to the array direction of the plurality of light emitting devices 130 and disposed on both sides of second bottom surface 312 respectively with second bottom surfaces 312 between two first inclined surfaces 313. In the virtual cross section, first inclined surface 313 is tilted so as to approach light diffusion plate 140 as the distance of first inclined surface 313 from optical axis OA increases. In the present embodiment, first inclined surface 313 is a curved surface concave relative to light diffusion plate 140 side in the virtual cross section.

Second bottom surface 312 and first inclined surface 313 may be connected smoothly, or connected discontinuously. When second bottom surface 312 and first inclined surface 313 are connected smoothly, “the end of first inclined surface 313 on bottom surface 311 side” is referred to a part, when a tangent is drawn from the outside of first inclined surface 313 in the virtual cross section, where the inclination of the tangent becomes zero (0).

In surface light source device 300 of the present embodiment with second bottom surface 312 being a curved surface, the reaching position (P4) of a light beam on bottom surface 311 is further from optical axis OA than the reaching position (P1) in surface light source device 100′ of the comparative example with bottom surface 111 being a flat surface.

Also in the modification, in the virtual cross section, the luminous intensity of light emitted from light emitting device 130 and having an angle relative to optical axis OA with an absolute value in a range of 0° to 60° is 1.5% or less relative to the maximum luminous intensity of light emitted from light emitting device 130. In addition, an emission surface is disposed so that, in the virtual cross section, when the absolute value of the maximum angle, in an angle range in which light having a luminous intensity of 70% or more of the maximum luminous intensity is emitted, relative to optical axis OA is set as θ, the emission surface intersects with straight line L having an angle equals to or more than θ, where the angle is larger one of the angles between optical axis OA and the straight line that passes the end of first inclined surface 313 on bottom surface 311 side and intersects with optical axis OA.

The inclination angle of second bottom surface 213 relative to first bottom surface 212 and the thickness of substrate 220 are appropriately set as long as emission surface 154 is disposed so as to intersect with above-described straight line L. The inclination angle of second bottom surface 312 relative to first bottom surface 212 may be, for example, increased to reduce the thickness of substrate 220. Alternatively, the inclination angle of second bottom surface 312 relative to first bottom surface 212 may be reduced to increase the thickness of substrate 220.

Therefore, in the virtual cross section, a light beam emitted from light emitting device 130 at an angle equals to or more than θ reaches ⅔ of a region from first inclined surface 313 side where the region is between optical axis OA and the end of bottom surface 311 on first inclined surface 313 side, and is divided into three equal parts. With this disposition, a light beam emitted from light emitting device 130 can reach a position further from optical axis OA on bottom surface 311. Therefore, luminance on light diffusion plate 140 can be made uniform compared to conventional surface light source device 100′ by allowing light reflected by bottom surface 311 to reach a position further from optical axis OA on light diffusion plate 140 than in surface light source device 100′ of the comparative example according to the inclination direction and reflection characteristics of bottom surface 311.

(Effects)

From the foregoing, in surface light source device 100, 200 or 300 according to the present embodiment, the reaching position of a light beam, emitted from emission surface 154, on bottom surface 111, 211 or 311 becomes further from optical axis OA by thickening substrate 120, or changing the shape of bottom surface 211 or 311, thereby reducing the difference between the luminous intensities at the part immediately above light emitting device 130 and at the outer peripheral part of light emitting device 130. Accordingly, the entire light diffusion plate 140 can be uniformly illuminated.

### Embodiment 2

Surface light source device 400 of embodiment 2 is different from surface light source device 100 of embodiment 1 in that surface light source device 400 has a circular shape in plan view. Therefore, the shapes of members configuring surface light source device 400 are mainly described in the following.

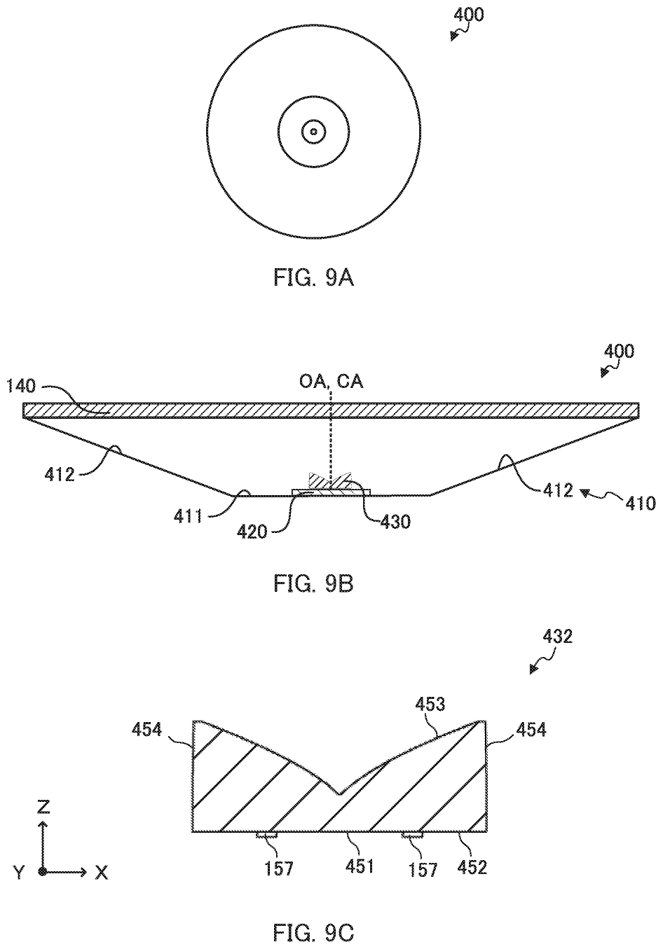

FIGS. 9A to 9C illustrate a configuration of surface light source device 400 of embodiment 2. FIG. 9A is a plan view of surface light source device 400 with light diffusion plate 140 removed, FIG. 9B is a cross-sectional view of surface light source device 400, and FIG. 9C is a cross-sectional view of light flux controlling member 432. As illustrated in FIGS. 9A to 9C, surface light source device 400 of embodiment 2 includes casing 410, substrate 420, light emitting devices 430 each including light emitting element 131 and light flux controlling member 432, and light diffusion plate 140. In the present embodiment, casing 410, substrate 420, light flux controlling member 432 and light diffusion plate 140 all has a circular shape in plan view.

Casing 410 includes bottom surface 411 and inclined surface 412. Bottom surface 411 has a circular shape in plan view. Inclined surface 412 is disposed at a position further than bottom surface 411 from optical axis OA in a cross section including optical axis OA of light emitting element 131. In the cross section including optical axis OA, inclined surface 412 is tilted so as to approach light diffusion plate 140 as the distance of inclined surface 412 from optical axis OA increases.

In the cross section including optical axis OA, inclined surface 412 may be in a form of a straight line, a curved line protruding toward light diffusion plate 140 side, or a curved line concave relative to light diffusion plate 140 side. In the present embodiment, inclined surface 412 is in a form of a straight line in the cross section including optical axis OA. Accordingly, inclined surface 412 is a side surface having an inverted truncated cone shape in the present embodiment.

Light flux controlling member 432 includes incidence surface 451, rear surface 452, reflection surface 453, emission surface 454 and leg 157. Incidence surface 451, rear surface 452, reflection surface 453, emission surface 454 and leg 157 are all rotationally symmetric (circularly symmetric) with the central axis of light flux controlling member 432 as the rotation axis.

In the cross section including optical axis OA, the luminous intensity of light emitted from light emitting device 430 and having an angle relative to optical axis OA with an absolute value in a range of 0° to 60° is 1.5% or less relative to the maximum luminous intensity of light emitted from light emitting device 430. In addition, emission surface 454 is disposed so that, in the cross section including optical axis OA, when the absolute value of the maximum angle, in an angle range in which light having a luminous intensity of 70% or more of the maximum luminous intensity is emitted, relative to optical axis OA is set as θ, emission surface 454 intersects with straight line L having an angle equals to or more than θ, where the angle is larger one of the angles between optical axis OA and the straight line that passes the end of inclined surface 412 on bottom surface 411 side and intersects with optical axis OA.

(Effects)

Surface light source device 400 of the present embodiment provides the same effects as that of surface light source device 100 of embodiment 1.

Although not specifically illustrated, the bottom surface may have first and second bottom surfaces also in the present embodiment. In such a case, the second bottom surface is tilted away from light diffusion plate 140 as the distance of the second bottom surface from optical axis OA increases in the cross section including optical axis OA. The second bottom surface in this case has a side shape in a truncated cone shape. In addition, the second bottom surface and the inclined surface may be curved lines concave relative to light diffusion plate 140 side in the cross section including optical axis OA.

This application claims priority based on Japanese Patent Application No. 2017-222891 filed on Nov. 20, 2017, the entire contents of which including the specifications and the drawings are incorporated herein by reference.

### INDUSTRIAL APPLICABILITY

The surface light source device according to the present invention is applicable to, for example, a backlight of a liquid crystal display device, a sign board, a commonly used illumination apparatus or the like.

### REFERENCE SIGNS LIST

100, 100′, 200, 300, 400 Surface light source device
101′ Display device
107 Member to be irradiated
110, 210, 310, 410 Casing
111, 211, 311, 411 Bottom surface
112, 313 First inclined surface
113 Second inclined surface
120, 220, 420 Substrate
130, 430 Light emitting device
131 Light emitting element
132, 432 Light flux controlling member
140 Light diffusion plate
151, 451 Incidence surface
152, 452 Rear surface
153, 453 Reflection surface
154, 454 Emission surface
157 Leg
212 First bottom surface
213, 312 Second bottom surface
412 Inclined surface
OA Optical axis
CA Central axis

1. A surface light source device, comprising:
a casing with an opening, the casing having a shape of a box;
a substrate disposed in the casing;
a light emitting device disposed on the substrate; and
a light diffusion plate disposed so as to cover the opening,
wherein the light emitting device includes
a light emitting element, and
a light flux controlling member configured to control light distribution of light emitted from the light emitting element,
wherein the casing includes
a bottom surface on which the substrate is disposed, and
an inclined surface disposed at a position further than the bottom surface from an optical axis of the light emitting element in a cross section including the optical axis,
wherein, in the cross section including the optical axis, the inclined surface is tilted so as to approach the light diffusion plate as a distance of the inclined surface from the optical axis increases,
wherein the light flux controlling member includes
an incidence surface disposed on a rear side so as to intersect with the optical axis, the incidence surface being configured to allow incidence of the light emitted from the light emitting element,
a rear surface disposed so as to surround the incidence surface, the rear surface extending away from the optical axis,
a reflection surface disposed on a front side and configured to reflect part of the light incident on the incidence surface into a direction substantially perpendicular to the optical axis, and
an emission surface disposed so as to connect between the reflection surface and the rear surface, the emission surface being configured to emit the light reflected by the reflection surface and the light incident on the incidence surface to an outside, and
wherein
in the cross section including the optical axis, a luminous intensity of first light is 1.5% or less relative to a maximum luminous intensity of light emitted from the light emitting device, the first light being emitted from the light emitting device and having an angle with an absolute value of 0 to 60° relative to the optical axis, and
the emission surface is disposed so that, in the cross section including the optical axis, when an absolute value of an maximum angle relative to the optical axis is set as θ, the emission surface intersects with a straight line having an angle equals to or more than θ, wherein the angle is larger one of angles between the optical axis and the straight line that passes an end of the inclined surface on a bottom surface side and intersects with the optical axis, the maximum angle being in an angle range in which light having a luminous intensity of 70% or more of the maximum luminous intensity is emitted.

2. The surface light source device according to claim 1, wherein:
the light emitting device includes a plurality of light emitting devices disposed in one direction on the substrate,
the inclined surface includes two inclined surfaces disposed parallel to an array direction of the plurality of light emitting devices and disposed on both sides of the bottom surface respectively with the bottom surface between the two inclined surfaces, wherein each of the two inclined surfaces is tilted so as to approach the light diffusion plate as a distance of each of the two inclined surfaces from the optical axis increases in a virtual cross section perpendicular to the array direction of the plurality of light emitting devices,
the reflection surface includes two reflection surfaces disposed on the front side, wherein each of the two reflection surfaces is configured to reflect the part of the light incident on the incidence surface into directions substantially perpendicular to the optical axis and substantially opposite to each other, and
the emission surface includes two emission surfaces disposed in a direction perpendicular to the optical axis with the two reflection surfaces between the two emission surfaces and disposed so as to face each other in the virtual cross section, wherein each of the two emission surfaces is configured to emit to the outside the light reflected by the two reflection surfaces and the light incident on the incidence surface.

3. The surface light source device according to claim 2, wherein the plurality of light emitting devices are arranged on the substrate in one row.

4. The surface light source device according to claim 2, wherein each of the two inclined surfaces is a planar surface.

5. The surface light source device according to claim 1, wherein a normal to a surface of the substrate is parallel to the optical axis of the light emitting element.

6. A display device comprising:
the surface light source device according to claim 1, and
a display member disposed on the light diffusion plate.
